(19) United States
(12) Patent Application Publication
(10) Pub. No.: US 2026/0063597 A1
(43) Pub. Date: Mar. 5, 2026

(54) REAGENT FREE ION CHROMATOGRAPHY SYSTEM WITH ELECTROCHEMICAL DETECTION AND DEVICES CONTAINING PLATINUM GROUP METALS

(71) Applicant: Dionex Corporation, Sunnyvale, CA (US)

(72) Inventors: Jun CHENG, San Jose, CA (US); Victor BARRETO, Campbell, CA (US); Yan LIU, Palo Alto, CA (US)

(21) Appl. No.: 18/825,079

(22) Filed: Sep. 5, 2024

(51) Int. Cl. G01N 30/14; B01D 15/36; B01D 15/42; B01J 23/40; G01N 30/32; G01N 30/64

(52) U.S. Cl. CPC G01N 30/14; B01D 15/361; B01D 15/424; B01J 23/40; G01N 30/32; G01N 30/64

(57) ABSTRACT

A method of analyzing a sample includes loading a sample to a separation column, generating an eluent to eluent the sample from the separation column, removing hydrogen peroxide or other electrolytic byproducts from the eluent using a catalytic material including a platinum group metal, and detecting compounds within the sample as they are eluted from the separation column.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### FIELD OF THE INVENTION

The present disclosure generally relates to the field of ion chromatography including removal of hydrogen peroxide and ghost peaks in reagent free ion chromatography-electrochemical detection with a device of platinum group metals.

### BACKGROUND OF THE INVENTION

Ion chromatography (IC) is a widely used analytical technique for the determination of anionic and cationic analytes in various sample matrices. Electrochemical detectors are often used in IC to detect analytes based on their redox potentials.

For reagent free ion chromatography (RFIC), the eluent is generated through an electrolytic process, which can result in the addition of hydrogen and/or oxygen and/or other electrolytic process byproducts to the eluent. Trace amounts of hydrogen in the eluent can combine with oxygen in the sample to form hydrogen peroxide. This can be particularly noticeable at high eluent concentrations, such as 100 mM KOH, and at high flow rates, such as 1.0 ml/min. At sufficient concentrations, the hydrogen peroxide can be detected by electrochemical detectors, resulting in unwanted peaks and increased noise.

There is a need to develop effective solutions to reducing or eliminating the impacts of electrolytic byproducts such as hydrogen peroxide formed in the eluent.

### BRIEF DESCRIPTION OF THE DRAWINGS

FIG. 1 illustrates an exemplary ion chromatography system, in accordance with various embodiments.

FIGS. 2, 3A, 3B, 4A, 4B, 5A, and 5B illustrate various embodiments of a device containing platinum group metals

FIG. 6 illustrates an example of using a Pt column to decompose electrolytic eluent generation by-products such as hydrogen peroxide

FIG. 7 illustrates another example of using a Pt column to decompose electrolytic eluent generation by-products such as hydrogen peroxide and reduce detector noise.

### DETAILED DESCRIPTION

Embodiments of reagent free ion chromatography system with electrochemical detection and devices containing platinum group metals are described herein.

The section headings used herein are for organizational purposes only and are not to be construed as limiting the described subject matter in any way.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless described otherwise, all technical and scientific terms used herein have a meaning as is commonly understood by one of ordinary skill in the art to which the various embodiments described herein belongs.

It will be appreciated that there is an implied “about” prior to the temperatures, concentrations, times, pressures, flow rates, cross-sectional areas, etc. discussed in the present teachings, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the foregoing general description and the following detailed description are exemplary and explanatory only and are not restrictive of the present teachings.

As used herein, “a” or “an” also may refer to “at least one” or “one or more.” Also, the use of “or” is inclusive, such that the phrase “A or B” is true when “A” is true, “B” is true, or both “A” and “B” are true. Further, unless otherwise required by context, singular terms shall include pluralities and plural terms shall include the singular.

A “system” sets forth a set of components, real or abstract, comprising a whole where each component interacts with or is related to at least one other component within the whole.

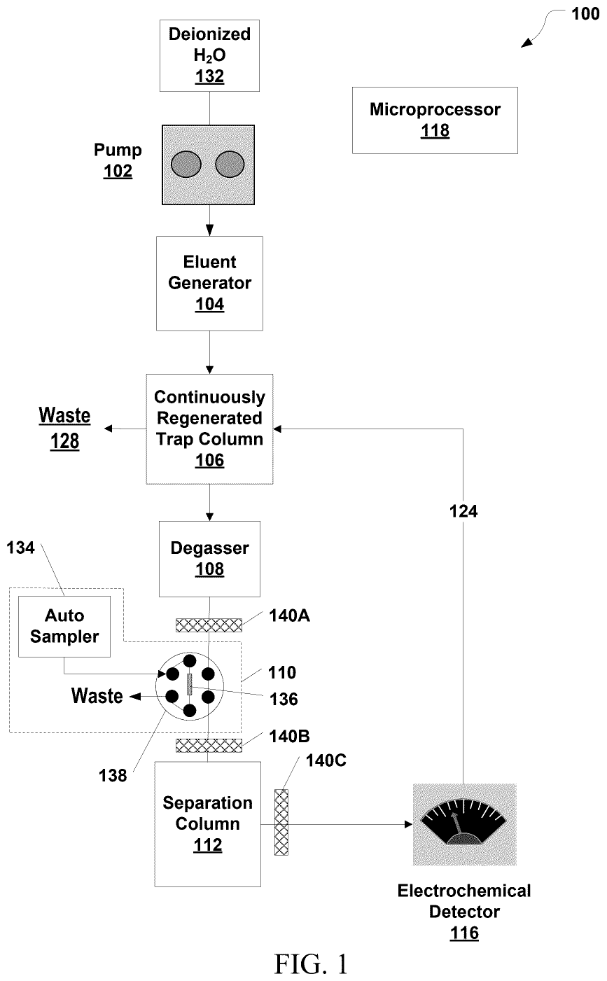

FIG. 1 illustrates an embodiment of a chromatography system 100. Chromatography system 100 may include a pump 102, an electrolytic eluent generator 104, a continuously regenerated trap column 106, a degasser 108, a sample injector 110, a chromatographic separation device 112, a detector 116, and a microprocessor 118. Chromatographic separation device 112 may be in the form of a capillary column (typically 0.4 mm internal diameter) or an analytical column (typical 4-mm internal diameter). Line 124 may be used to transfer liquid from an outlet of the electrochemical detector 116 to an inlet of the continuously regenerated trap column 106. Liquid from the outlet of the continuously regenerated trap column 106 can be directed to waste 128.

Pump 102 can be configured to pump a liquid from a liquid source 132, such as deionized water, and be fluidically connected to electrolytic eluent generator 104. Pump 102 can be configured to transport the liquid at a pressure ranging from about 20 PSI to about 15,000 PSI. Under certain circumstances, pressures greater than 15,000 PSI may also be implemented. It should be noted that the pressures denoted herein are listed relative to an ambient pressure (13.7 PSI to 15.2 PSI). Pump 102 may be in the form of a high-pressure liquid chromatography (HPLC) pump. In addition, pump 102 can also be configured so that the liquid only touches an inert portion of pump 102 so that a significant amount of impurities does not leach out. In this context, significant means an amount of impurities that would interfere with the intended measurement. For example, the inert portion can be made of polyether ether ketone (PEEK) or at least coated with a PEEK lining, which does not leach out a significant amount of ions when exposed to a liquid.

An eluent is a liquid that contains an acid, base, salt, or mixture thereof and can be used to elute an analyte through a chromatography column. In addition, an eluent can include a mixture of a liquid and a water miscible organic solvent, where the liquid may include an acid, base, salt, or combination thereof. Electrolytic eluent generator 104 is configured to generate a generant. A generant refers to a particular species of acid, base, or salt that can be added to the eluent. In an embodiment, the generant may be a base such as cation hydroxide or the generant may be an acid such as carbonic acid, phosphoric acid, acetic acid, methanesulfonic acid, or a combination thereof.

Referring to FIG. 1, eluent generator 104 can be configured to receive the liquid from pump 102 and then add a generant to the liquid. The liquid containing the generant can be outputted from eluent generator 104 to an inlet of continuously regenerated trap column 106.

Continuously regenerated trap column 106 is configured to remove cationic or anionic contaminants from the eluent. Continuously regenerated trap column 106 can include an ion exchange bed with an electrode at the eluent outlet. An ion exchange membrane stack can separate the eluent from a second electrode and contaminate ions can be swept through the ion exchange membrane stack towards the second electrode. The ion exchange membrane stack can include one or more ion exchange membranes. In various embodiments, anion removal can utilize an anion exchange bed with a cathode at the eluent outlet separated from an anode by an anion exchange membrane. Alternatively, cation removal can utilize a cation exchange bed with an anode at the eluent outlet separated from a cathode by a cation exchange membrane.

Degasser 108 may be used to remove residual gas. In an embodiment, a residual gas may be electrolytically generated such as hydrogen and/or oxygen. Degasser 108 may include a tubing section that is gas permeable and liquid impermeable such as, for example, amorphous fluoropolymers. The flowing liquid can be outputted from degasser 108 to sample injector 110 with a substantial portion of the gas removed.

Sample Injector 110 can be used to inject a bolus of a liquid sample into an eluent stream. The liquid sample may include a plurality of chemical constituents (i.e., matrix components) and one or more analytes of interest. The sample injector 110 can include an auto sampler 134, sample loop 136, and a multiport valve 138. The autosampler 134 can draw a sample from a sample container. The multiport valve 138 can be in a first position to allow the sample to fill the sample loop 136. After the sample loop 136 is filled to the desired level, the multiport valve can switch to a second position and the eluent stream can drive the sample onto the chromatographic separation device 112.

Chromatographic separation device 112 can be used to separate various matrix components present in the liquid sample from the analyte(s) of interest. Typically, chromatographic separation device 112 may be in the form of a hollow cylinder that contains a packed stationary phase. As the liquid sample flows through chromatographic separation device 112, the matrix components and target analytes can have a range of retention times for eluting off chromatographic separation device 112. Depending on the characteristics of the target analytes and matrix components, they can have different affinities to the stationary phase in chromatographic separation device 112. An output of chromatographic separation device 112 can be fluidically connected to detector 116.

Detector 116 may be in the form of an electrochemical detector, a refractive index detector, a conductivity detector, or a combination thereof.

An electronic circuit may include microprocessor 118, a timer, and a memory portion. In addition, the electronic circuit may include a power supply that are configured to apply a controlling signal, respectively. Microprocessor 118 can be used to control the operation of chromatography system 100. Microprocessor 118 may either be integrated into chromatography system 100 or be part of a personal computer that communicates with chromatography system 100. Microprocessor 118 may be configured to communicate with and control one or more components of chromatography system such as pump 102, eluent generator 104, sample injector 110, and detector 116. The memory portion may be used to store instructions to set the magnitude and timing of the current waveform with respect to the switching of sample injector 110 that injects the sample.

A device containing platinum group metals 140 can be placed upstream of sample injector 110 at 140A, upstream of the separation column 112 at 140B, or downstream of the separation column 112 at 140C. A device containing platinum group metals 140 can be in various physical embodiments. The device may contain platinum group metals in form of metal particles, metal mesh, metal screen, metal wire, or polymeric or silica particles coated with platinum group metals. In various embodiments, the hydrogen peroxide elimination device 140 can be incorporated as a frit or screen into separation column 112, such as at the inlet, the outlet, or both. In other embodiments, the hydrogen peroxide elimination device 140 can be a separate component, such as a small column, that can be positioned in the various locations. The hydrogen peroxide elimination device 140 can include a catalyst, such as a platinum group metal catalyst. The device containing platinum group metals 140 can catalyze the decomposition of hydrogen peroxide, conversion of residual hydrogen and oxygen to water, or conversion other electrolytic byproducts into other forms that do not interfere with the detection of target analytes using detection methods such as electrochemical detection.

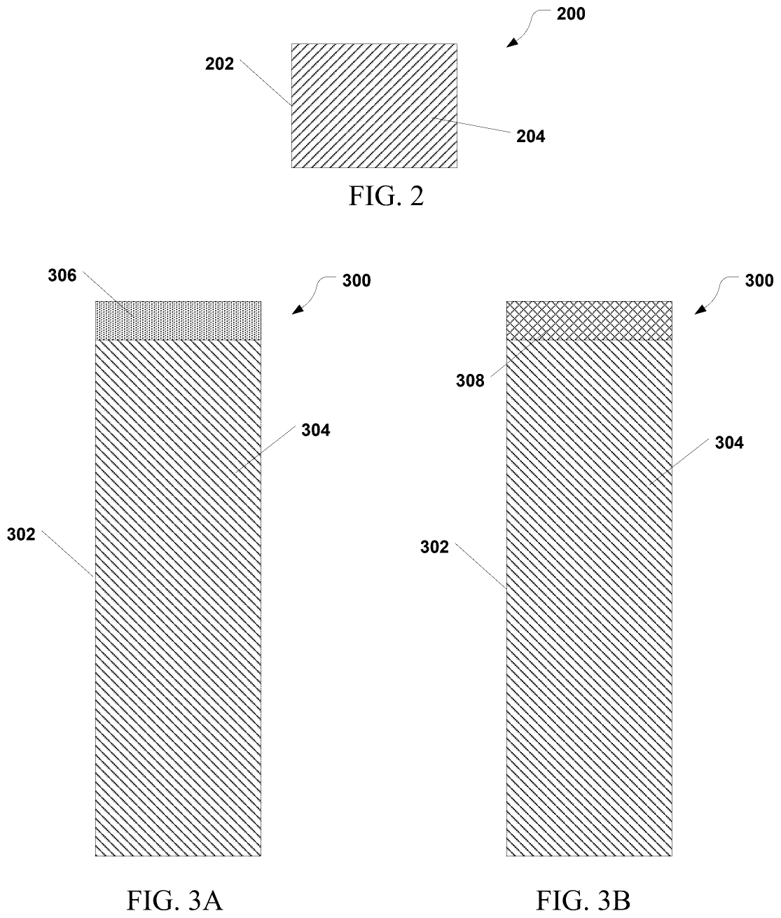

FIG. 2 illustrates a device containing platinum group metals 200 in the form of a separate component. The device containing platinum group metals 200 can include body 202 having a platinum group metal catalyst 204 housed within the body. In various embodiments, the platinum group metal catalyst 204 can be polymer beads of a porous monolithic polymer with a platinum group metal catalyst bound to the polymer. In other embodiments, the catalyst can be a wire. The wire can be a platinum group metal. Alternatively, the wire can be coated with the platinum group metal or an alloy including a platinum group metal. The device containing platinum group metals 200 can be in the form of a short column, similar to a guard column, or can be in the form of a filter disk with the housing 202 holding a disk of the catalyst 204.

FIGS. 3A and 3B illustrate a separation column 300 having a device containing platinum group metals 306 or 308 at the inlet end. The separation column 300 can include a body 302. The body 302 can be at least partially filled with a separation media 304. The separation media 304 can be resin particles or a monolithic media and can generally have a surface that can interact with an analyte to separate various components of the analyte. The device containing platinum group metals 306 of FIG. 3A can include a resin frit, such as a porous monolithic polymer with a platinum group metal catalyst bound to the surface thereof. The hydrogen peroxide elimination device 308 of FIG. 3B can include a screen frit, such as a wire mesh of platinum group metal or alloys thereof.

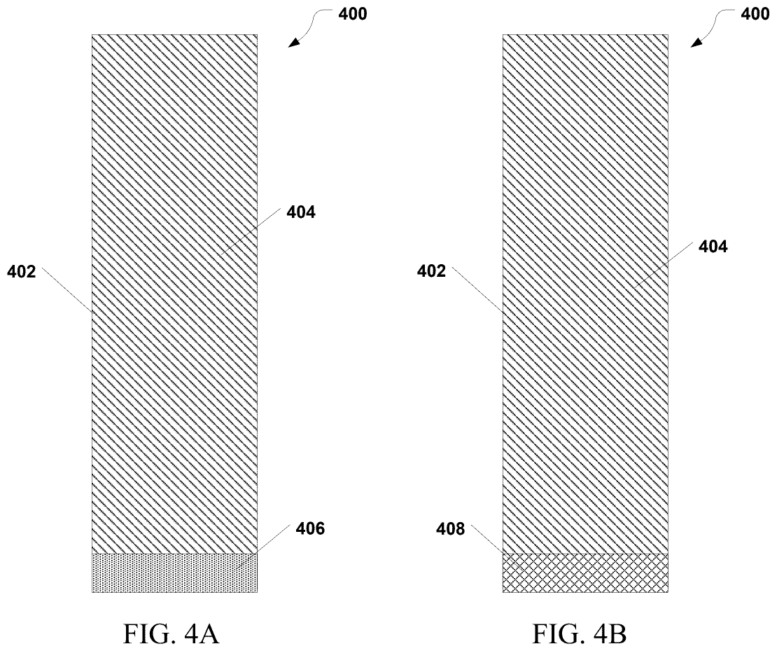

FIGS. 4A and 4B illustrate a separation column 400 having a device containing platinum group metals 406 or 408 at the outlet end. The separation column 400 can include a body 402. The body 402 can be at least partially filled with a separation media 404. The separation media 404 can be resin particles or a monolithic media and can generally have surface active groups that can interact with an analyte to separate various components of the analyte, such as anion exchange sites or cation exchange sites. The hydrogen peroxide elimination device 406 of FIG. 4A can include a resin frit, such as a porous monolithic polymer with a platinum group metal catalyst bound to the surface thereof. The device containing platinum group metals 408 of FIG. 4B can include a screen frit, such as a wire mesh of platinum group metal or alloys thereof.

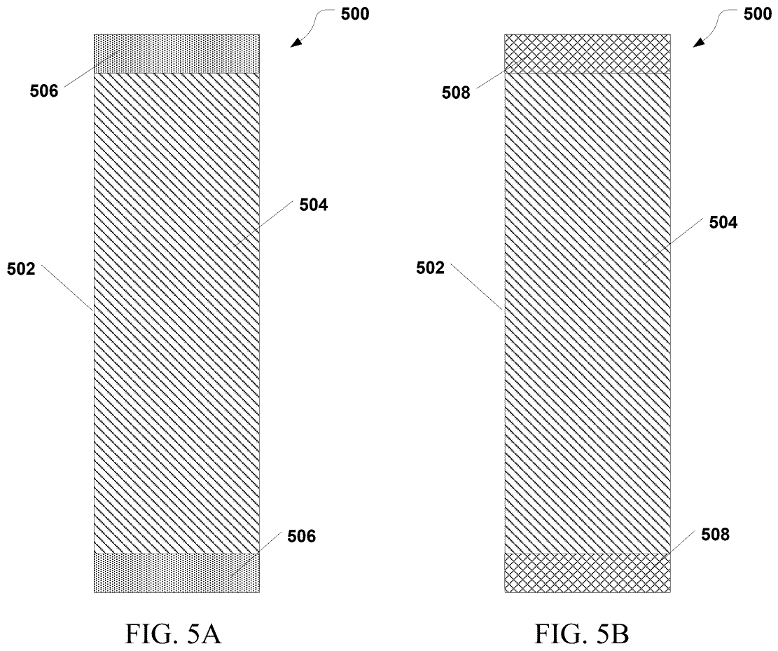

FIGS. 5A and 5B illustrate a separation column 500 having hydrogen peroxide elimination device 506 or 508 at both the inlet end and the outlet end. The separation column 500 can include a body 502. The body 502 can be at least partially filled with a separation media 504. The separation media 504 can be resin particles or a monolithic media and can generally have surface active groups that can interact with an analyte to separate various components of the analyte, such as anion exchange sites or cation exchange sites. The device containing platinum group metals 506 of FIG. 5A can include a resin frit, such as a porous monolithic polymer with a platinum group metal catalyst bound to the surface thereof. The device containing platinum group metals 508 of FIG. 5B can include a screen frit, such as a wire mesh of platinum group metal or alloys thereof.

### EXAMPLES

### Example 1

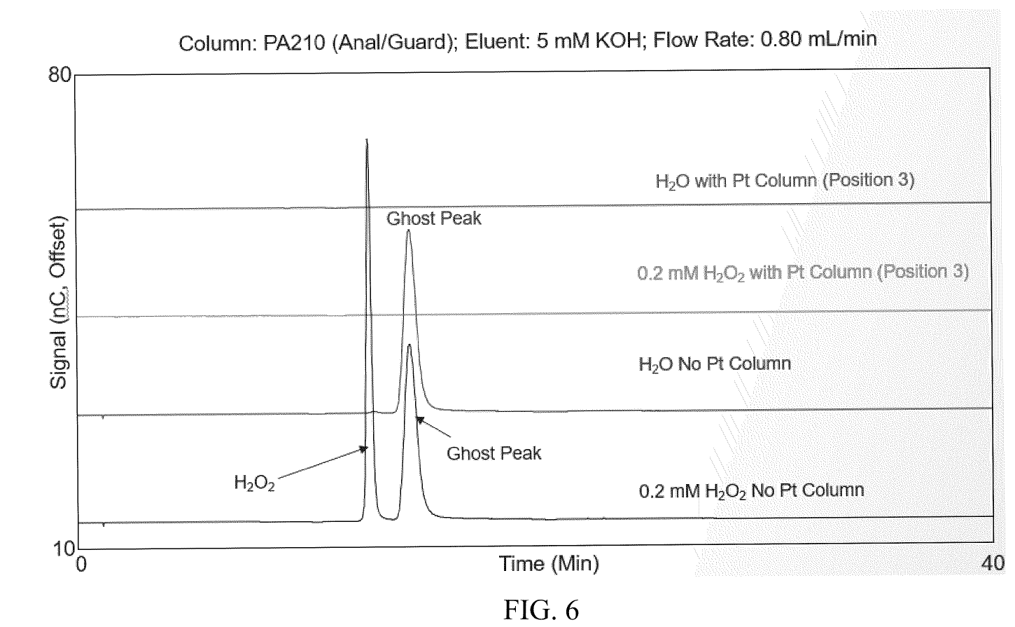

A sample containing water or 0.2 mM hydrogen peroxide is injected onto a Dionex CarboPac PA210 separation column. 5 mM KOH at a flow rate of 0.80 mL/min flowed through the column for 40 min, with and without a device containing platinum group metals 140C between the separation column and an electrochemical detector. FIG. 6 shows the resulting chromatogram. A hydrogen peroxide peak can be observed for the 0.2 mM hydrogen peroxide without a device containing platinum group metals. Additionally, a ghost peak resulting from residual hydrogen in the eluent can be observed for both the water and 0.2 mM hydrogen peroxide without the hydrogen peroxide elimination device. The presence of the device containing platinum group metals 140C between the separation column and the electrochemical detector eliminates the ghost peak in both the water and 0.2 mM hydrogen peroxide and the hydrogen peroxide peak in the 0.2 mM hydrogen peroxide.

### Example 2

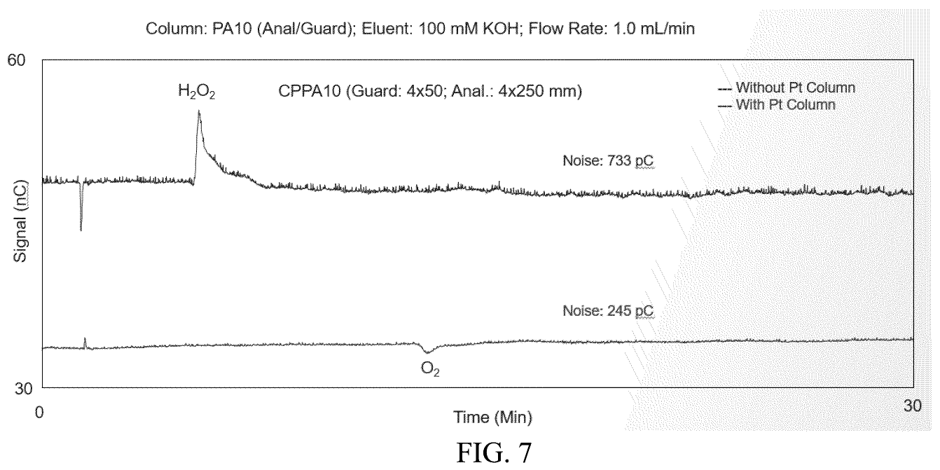

A sample containing water injected onto a Dionex CarboPac PA10 separation column. 100 mM KOH at a flow rate of 1.0 mL/min flowed through the column for 30 min, with and without a device containing platinum group metals upstream of the separation column 140B. FIG. 7 shows the resulting chromatogram. A hydrogen peroxide peak can be observed in the absence of a device containing platinum group metals, with a noise level of 733 pC. The presence of the device containing platinum group metals upstream of the separation column eliminates the hydrogen peroxide peak and reduces the noise to 245 pC. An oxygen negative peak (dip) can be observed due to the decomposition of hydrogen peroxide by its elimination device 140B.

What is claimed is:

1. A device containing platinum group metals comprising:
a body, and
a catalytic material within the body, the catalytic material including a platinum group metal.

2. The device of claim 1, wherein the device is a separation column and further includes a separation media within the body.

3. The device of claim 2, where the catalytic material is at an inlet of the device and the separation media is after the catalytic material.

4. The device of claim 2, where the catalytic material is at an outlet of the device and the separation media is before the catalytic material.

5. The device of claim 2, where the catalytic material is at both an inlet and an outlet of the device and the separation media is positioned between the catalytic material at the inlet and the catalytic material at the outlet.

6. The device of claim 1, wherein the catalytic material includes metal particles, a metal mesh, a metal screen, a metal wire, or any combination thereof.

7. The device of claim 1, wherein the catalytic material includes polymeric particles or silica particles coated with the platinum group metal.

8. An ion chromatography system comprising:
an eluent generator;
a separation column;
a detector; and
a device containing platinum group metals containing a catalytic material including a platinum group metal.

9. The ion chromatography system of claim 8, wherein the device is downstream of the eluent generator and upstream of the separation column.

10. The ion chromatography system of claim 8, wherein the device is downstream of the separation column and upstream of the detector.

11. The ion chromatography system of claim 8, wherein the device is incorporated into the separation column.

12. The ion chromatography system of claim 11, wherein the device is at an inlet of the separation column.

13. The ion chromatography system of claim 11, wherein the device is at an outlet of the separation column.

14. The ion chromatography system of claim 11, wherein the device is at both an inlet and an outlet of the separation column.

15. The ion chromatography system of claim 1, wherein the catalytic material includes metal particles, a metal mesh, a metal screen, a metal wire, or any combination thereof.

16. The ion chromatography system of claim 1, wherein the catalytic material includes polymeric particles or silica particles coated with the platinum group metal.

17. A method of analyzing a sample comprising:
loading a sample to a separation column;
generating an eluent to eluent the sample from the separation column;
removing hydrogen peroxide or other electrolytic byproducts from the eluent using a catalytic material including a platinum group metal; and
detecting compounds within the sample as they are eluted from the separation column.

18. The method of claim 17, wherein the catalytic material includes metal particles, a metal mesh, a metal screen, a metal wire, or any combination thereof.

19. The method of claim 17, wherein the catalytic material includes polymeric particles or silica particles coated with the platinum group metal.

20. The method of claim 17, wherein the catalytic material is downstream of an eluent generator used in generating the eluent, and upstream of a detector used in detecting compounds.
